(19) United States
(12) Patent Application Publication
(10) Pub. No.: US 2026/0316546 A1
(43) Pub. Date: Oct. 15, 2026

(54) ENGINE MOUNT

(71) Applicant: ATRO LLC, St. Clair, MO (US)

(72) Inventor: Joseph A. KLEINIGGER, Bourbon, MO (US)

(21) Appl. No.: 19/179,466

(22) Filed: Apr. 15, 2025

(51) Int. Cl. B60K 5/12

(52) U.S. Cl. CPC B60K 5/1216

(57) ABSTRACT

An engine mount for connecting an engine to a support beam. The engine mount comprises an engine connection bracket configured to be connected to the engine by at least one first fastener, a beam connection bracket configured to be connected to the beam by at least one second fastener, a first elastomer interposed between the engine connection bracket and the beam connection bracket, and a second elastomer interposed between the engine connection bracket and the beam connection bracket. The first elastomer and the second elastomer are different materials and have different Bayshore resilience percentages.

### FIELD OF THE INVENTION

This disclosure relates generally to the field of mounts, and in particular for an engine mount.

### BACKGROUND OF THE INVENTION

Internal combustion engines function by coupling reciprocal movement of pistons of the engine with an output of the engine. Such engines can be used in a plurality of applications, including in trucks (e.g., heavy duty trucks) and in other vehicles. Trucks use the engine for powering wheels of the trucks for propelling the trucks. Mounts for the engine that minimize the transmission of vibrations from the engine to the supports for the engine are desired.

### SUMMARY OF THE INVENTION

The present invention, according to one aspect, is directed to an engine assembly for a truck. The engine assembly comprises an engine for powering the truck, a support beam for supporting a portion of the engine, an engine connection bracket connected to the engine by at least one first fastener, a beam connection bracket connected to the support beam by at least one second fastener, a first elastomer interposed between the engine connection bracket and the beam connection bracket, and a second elastomer interposed between the engine connection bracket and the beam connection bracket. The first elastomer and the second elastomer are different materials and have different Bayshore resilience percentages.

Yet another aspect of the present invention is to provide an engine mount for connecting an engine to a support beam. The engine mount comprises an engine connection bracket configured to be connected to the engine by at least one first fastener, a beam connection bracket configured to be connected to the support beam by at least one second fastener, a first pad comprising a first elastomer interposed between the engine connection bracket and the beam connection bracket, and at least one second pad comprising a second elastomer interposed between the engine connection bracket and the beam connection bracket. The first elastomer and the second elastomer are different materials and have different Bayshore resilience percentages.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a side view of an engine mount according to an embodiment of the present invention connecting an engine to a support beam of a vehicle.

FIG. 2 is a front view of a prior art engine mount.

FIG. 3 is a tilted front view of the prior art engine mount.

FIG. 4 is a front perspective view of an engine mount according to the present invention.

FIG. 5 is an exploded front perspective view of the engine mount according to the present invention.

FIG. 6 is a front view of the engine mount according to the present invention.

FIG. 7 is a rear view of the engine mount according to the present invention.

FIG. 8 is a top view of the engine mount according to the present invention.

FIG. 9 is a bottom view of the engine mount according to the present invention.

FIG. 10 is a side view of the engine mount according to the present invention.

FIG. 11 is a front perspective view of a rail connecting bracket of the engine mount according to the present invention.

FIG. 12 is a front view of the rail connecting bracket of the engine mount according to the present invention.

FIG. 13 is a first perspective view of an engine connecting bracket of the engine mount according to the present invention.

FIG. 14 is a second perspective view of the engine connecting bracket of the engine mount according to the present invention.

FIG. 15 is a top view of the engine connecting bracket of the engine mount according to the present invention.

FIG. 16 is a bottom view of the engine connecting bracket of the engine mount according to the present invention.

FIG. 17 is a front view of the engine connecting bracket of the engine mount according to the present invention.

FIG. 18 is a rear view of the engine connecting bracket of the engine mount according to the present invention.

FIG. 19 is a side view of the engine connecting bracket of the engine mount according to the present invention.

FIG. 20 is a front perspective view of an overload pad of the engine mount according to the present invention.

FIG. 21 is a rear perspective view of the overload pad of the engine mount according to the present invention.

FIG. 22 is a front view of the overload pad of the engine mount according to the present invention.

FIG. 23 is a rear view of the overload pad of the engine mount according to the present invention.

FIG. 24 is a top view of the overload pad of the engine mount according to the present invention.

FIG. 25 is a bottom view of the overload pad of the engine mount according to the present invention.

FIG. 26 is a perspective view of a main pad of the engine mount according to the present invention.

FIG. 27 is a front view of the main pad of the engine mount according to the present invention.

Certain terminology will be used in the following description for convenience in reference only and will not be limiting. Said terminology will include the words specifically mentioned, derivatives thereof, and words of similar import.

### DETAILED DESCRIPTION

For purposes of description herein, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

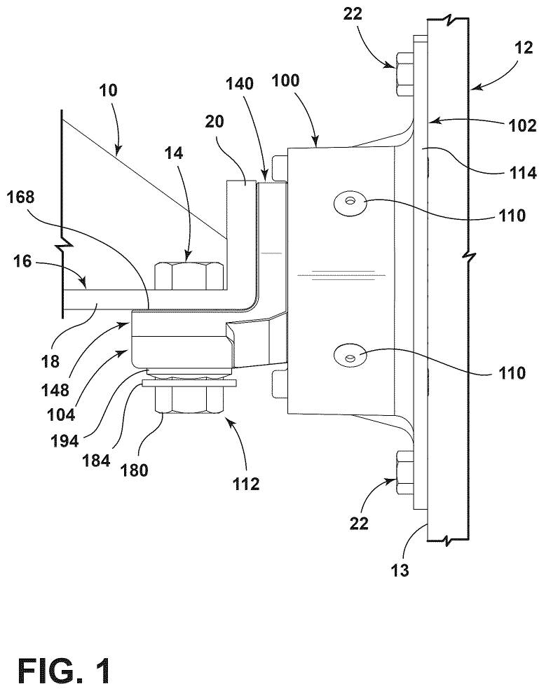

FIG. 1 illustrates an engine mount 100 according to an embodiment of the present invention for connecting a rear side of an engine 10 to a support beam 12 of a vehicle (e. g., a truck). As is well known to those skilled in the art, the engine 10 is used to propel wheels of the vehicle. However, a byproduct of a functioning engine 10 is vibrations from motion of pistons of the engine 10. The engine mount 100 according to an embodiment of the present invention serves not only to mount the engine 10 to the vehicle via the support beam 12, but also serves to dampen vibrations emitted by the engine 10 from passing to the support beam 12 and the rest of the vehicle. As shown in FIG. 1, vertically oriented engine bolts 14 connect the engine mount 100 to an L-shaped bracket 16 of the engine 10. In the illustrated example, a horizontal portion 18 of the L-shaped bracket 16 rests on the engine mount 100 and a vertical portion 20 of the L-shaped bracket 16 abuts against another portion of the engine mount 100, with the vertically oriented engine bolts 14 extending through the horizontal portion 18 of the L-shaped bracket 16. As shown in FIG. 1, horizontally oriented beam bolts 22 can connect the engine mount 100 to the support beam 12 at a top and a bottom of the engine mount 100.

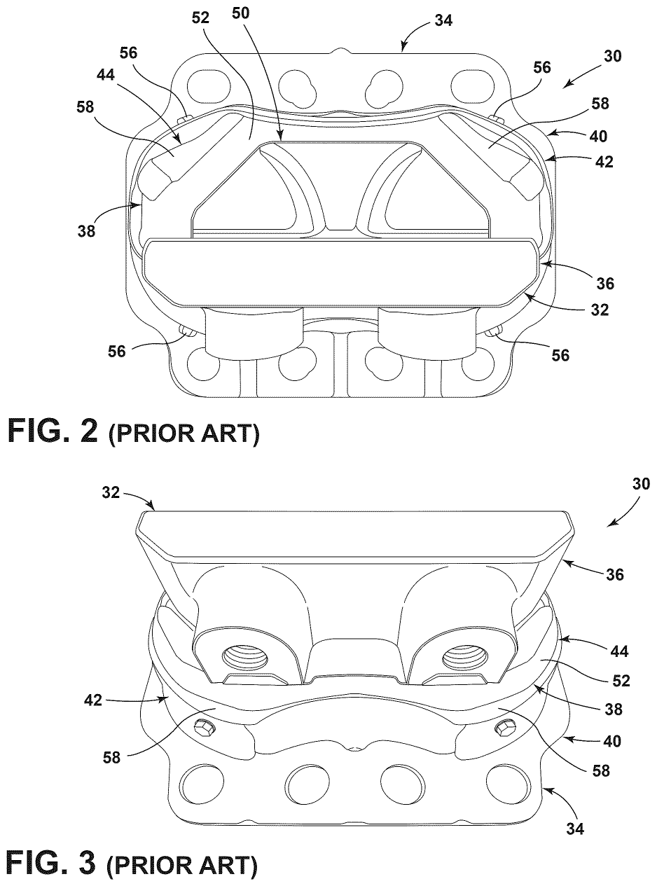

FIGS. 2-3 illustrate a prior art engine mount 30. The prior art engine mount 30 had previously been used to connect the engine 10 to the support beam 12. The prior art engine mount 30 included a first member 32 for direct connection to the engine 10 and a second member 34 for direct connection to the support beam 12. The first member 32 included a horizontal portion 36 for supporting the engine 10 and an insertion portion 38 that was inserted into the second member 34 of the prior art engine mount 30. The second member 34 of the prior art engine mount 30 included a vertical portion 40 for connection to the support beam 12, with the second member 34 including an envelope portion 42 extending from the vertical portion 40. The envelope portion 42 defined a receiving slot 44 for accepting the insertion portion 38 of the first member 32 therein. The second member 34 was formed entirely of metal. The first member 32 included a metal inner area 50 and an elastomeric outer area 52, with the metal inner area 50 pressed into the elastomeric outer area 52. The elastomeric outer area 52 of the first member 32 was connected to the envelope portion 42 of the second member 34 by pins 56 that extend through plastic connectors 58 connected to the elastomeric outer area 52. Further prior art mounts employ hydraulic dampeners to reduce transmission of vibrations from the engine. A better engine mount and better vibration dampening is desired.

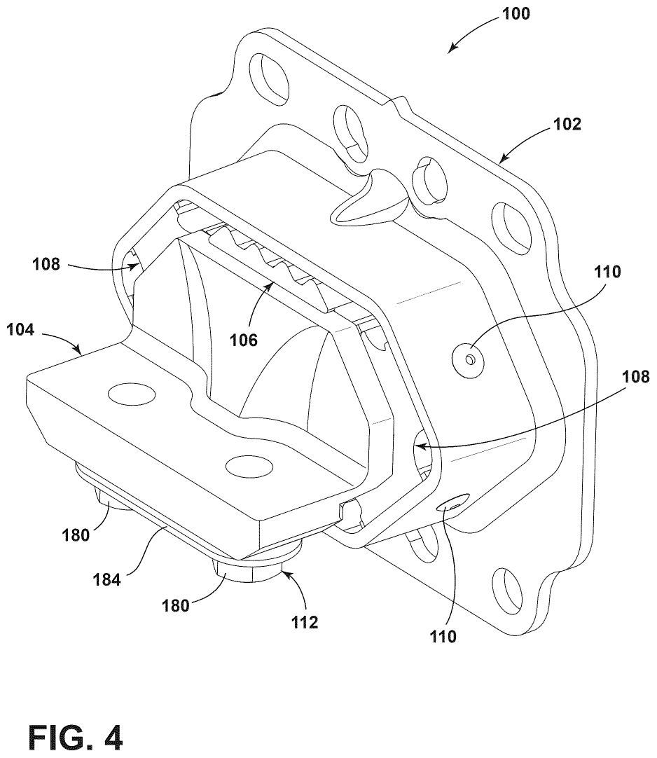

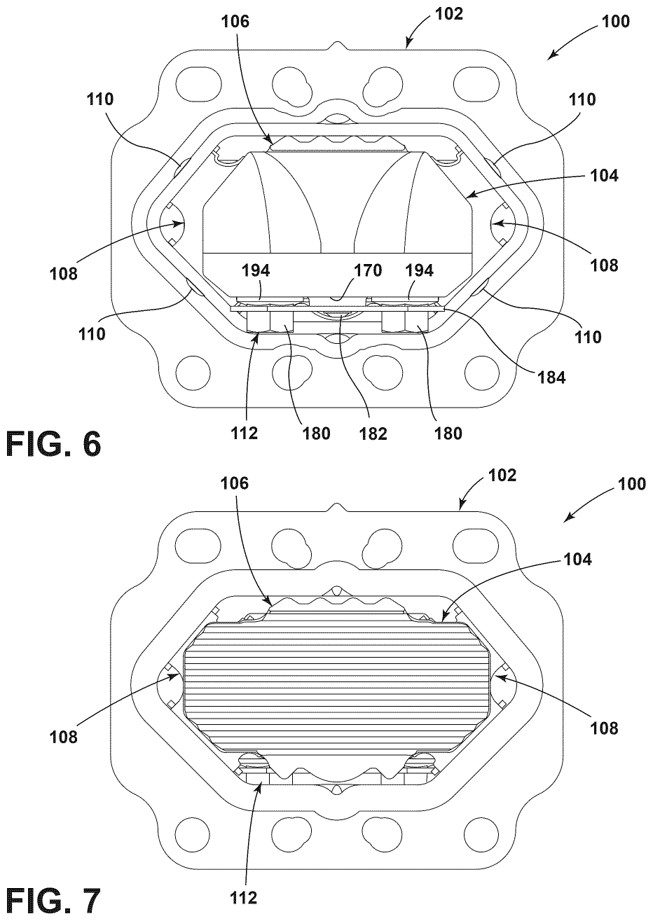

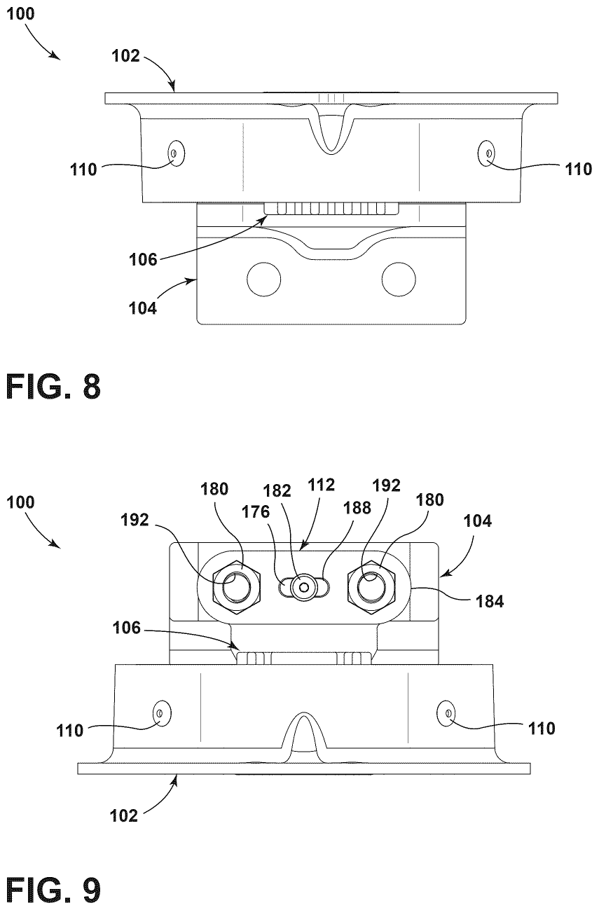

The engine mount 100 of the present invention (FIGS. 4-10) exhibits improved vibration dampening between the engine 10 to the support beam 12. The engine mount 100 of the present invention includes a beam connection bracket 102, an engine connection bracket 104, an overload pad 106, main pads 108, fasteners 110 and an engine connection assembly 112. The beam connection bracket 102 is connected to the support beam 12. The engine connection bracket 104 connects to the engine 10, with assistance from the engine connection assembly 112 in the illustrated embodiment. The fasteners 110 assist in maintaining the main pads 108 in position between the engine connection bracket 104 and the beam connection bracket 102. The overload pad 106 is also positioned between the engine connection bracket 104 and the beam connection bracket 102. The overload pad 106 and the main pads 108 combine to dampen vibrations passing from the engine 10 to the support beam 12.

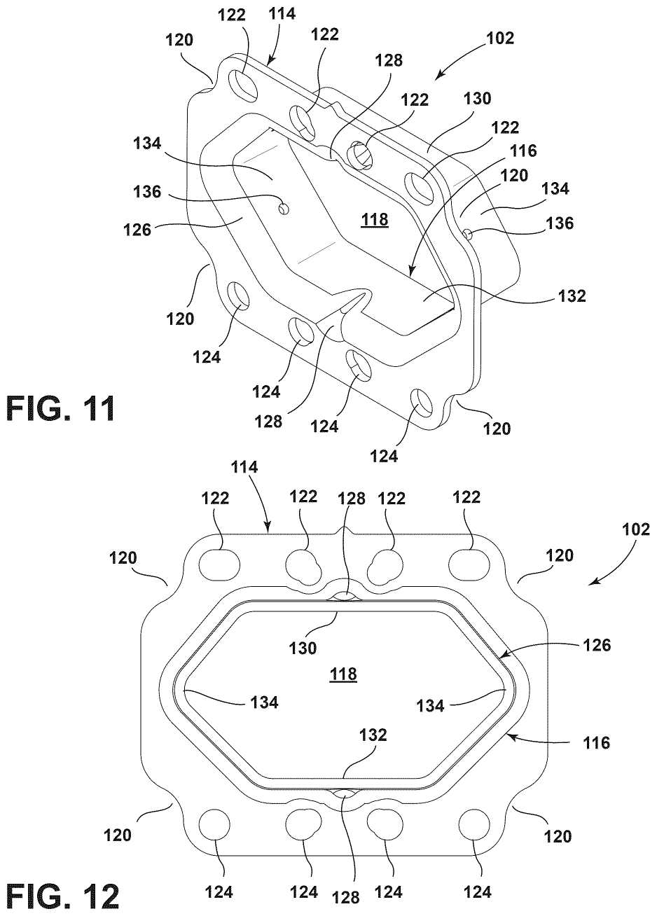

In the illustrated example, the beam connection bracket 102 (FIGS. 11-12) connects the engine mount 100 to the support beam 12. The beam connection bracket 102 includes a connection plate 114 and a tubular sleeve 116 connected to a center area of the connection plate 114, with the tubular sleeve 116 forming an engine connection bracket receiving area 118. The connection plate 114 can be substantially rectangular and can include corner recesses 120 to reduce material. However, it is contemplated that the connection plate 114 can have any configuration adapted for secure connection to the support beam 12. The connection plate 114 can include top bolt holes 122 and bottom bolt holes 124. As shown in FIG. 1, the bolts 22 extend through the top bolt holes 122 and the bottom bolt holes 124 of the connection plate 114 to connect the beam connection bracket 102, and thereby the engine mount 100, to the support beam 12. While four top bolt holes 122 and four bottom bolt holes 124 are shown, it is contemplated that any number of top bolt holes 122 and bottom bolt holes 124 could be used. It is further contemplated that side bolt holes could be employed.

The illustrated tubular sleeve 116 of the beam connection bracket 102 extends perpendicularly from the connection plate 114 via a transition section 126. The transition section 126 can include a plurality of curved strengthening projections 128 as shown in FIGS. 11 and 12 to strengthen the tubular sleeve 116 and the connection of the tubular sleeve 116 to the connection plate 114. The tubular sleeve 116 in the illustrated embodiment forms a substantially hexagonal opening defining the engine connection bracket receiving area 118, although other shaped openings are contemplated, depending on the exterior periphery of the overload pad 106 and the engine connection bracket 104. The tubular sleeve 116 includes a top wall 130, a bottom wall 132 and a pair of opposite angled side walls 134. Each of the angled side walls 134 include fastener openings 136 for accepting the fasteners 110 therethrough. It is contemplated that the beam connection bracket 102 can be formed of metal (e.g., formed steel).

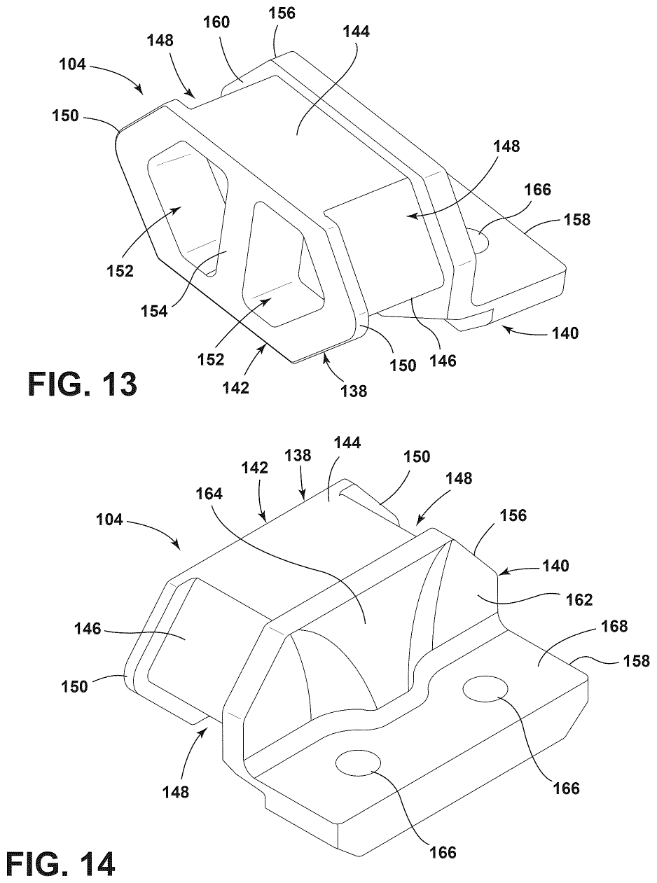

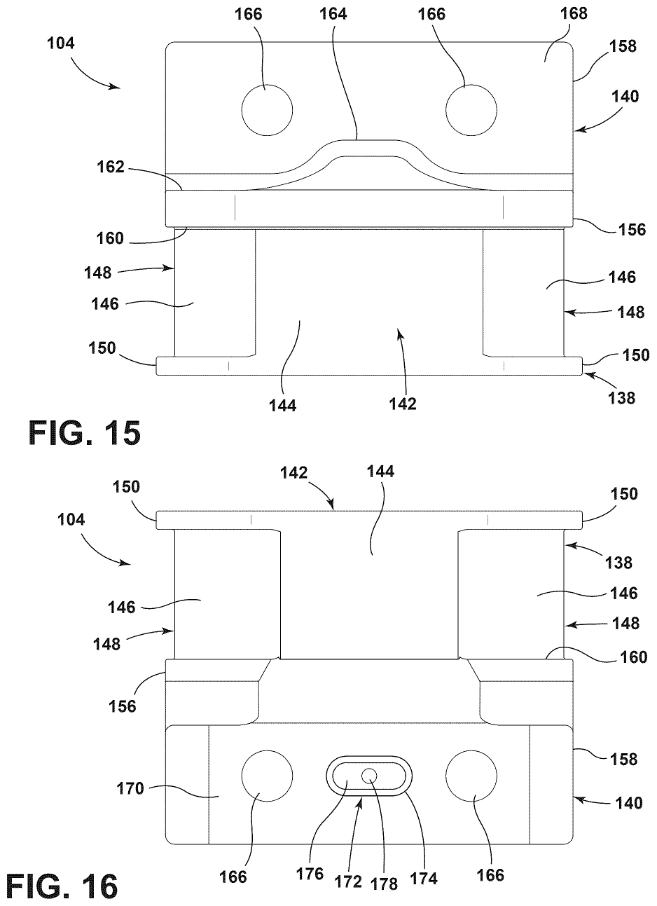

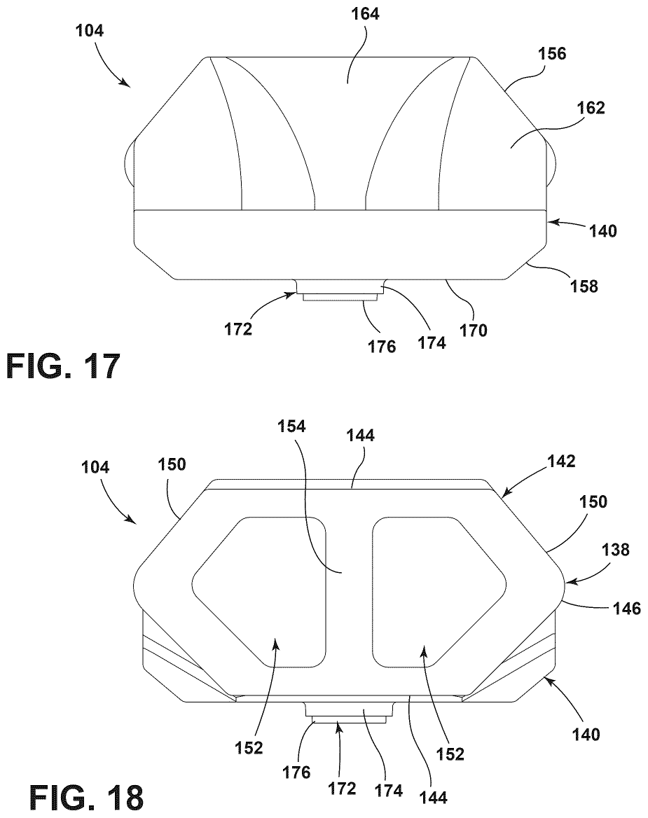

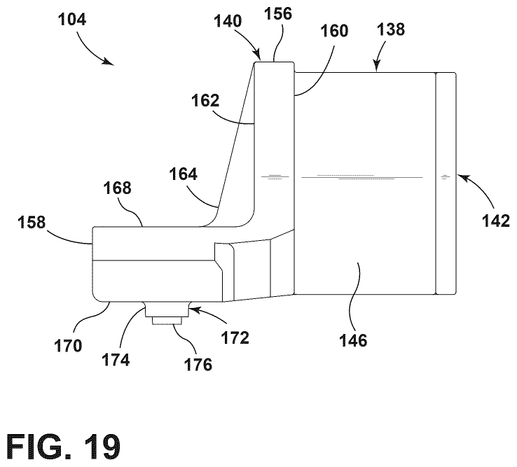

In the illustrated example, the engine connection bracket 104 is received within the beam connection bracket 102 to connect the engine mount 100 to the engine 10. The engine connection bracket 104 (FIGS. 13-19) includes a main block section 138 and an L-shaped section 140 integral with the main block section 138. The main block section 138 has a substantially hexagonally shaped body 142 having a pair of opposite long sides 144 and a pair of opposite angled sides 146. The pair of opposite angled sides 146 include an L-shaped channel 148 defined on a first side by an extension lip 150 and on a second side by the L-shaped section 140 (see FIGS. 13-16). The main block section 138 includes a pair of internal recesses 152 divided by a divider wall 154. The internal recesses 152 assist in connecting the engine connection bracket 104 to the overload pad 106, and can also be used to reduce the amount of material needed to form the engine connection bracket 104. As discussed herein, the main block section 138 is received within the beam connection bracket 102.

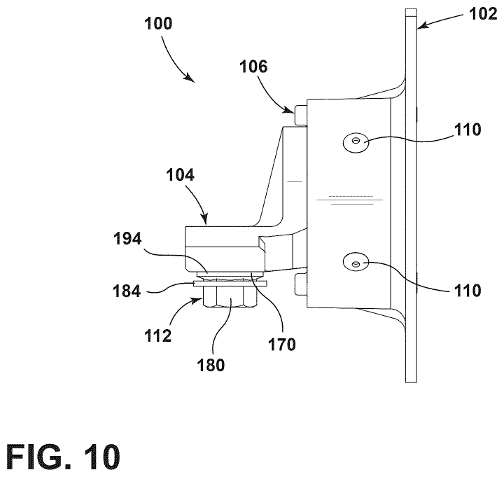

The illustrated engine connection bracket 104 has the L-shaped section 140 integral with the main block section 138, with the L-shaped section 140 being connected to the engine 10. The L-shaped section 140 includes a vertical wall 156 and a substantially perpendicular horizontal wall 158. The vertical wall 156 includes a first side 160 integral with the main block section 138 that forms an end of the L-shaped channel 148 and a second side 162 supporting the engine 10 as illustrated in FIG. 10. The second side 162 of the vertical wall 156 also includes a center strengthening and engagement ridge 164 that is also partially connected to the horizontal wall 158 as illustrated in FIG. 14. The center strengthening and engagement ridge 164 strengthens the engine connection bracket 104 and can be received in a corresponding channel in the engine 10 to assist in properly locating the engine 10 on the engine connection bracket 104 and maintaining the engine 10 in a proper position.

In the illustrated example, the horizontal wall 158 of the L-shaped section 140 of the engine connection bracket 104 is configured to be connected to the engine 10. A top surface 168 of the horizontal wall 158 of the L-shaped section 140 of the engine connection bracket 104 supports the engine 10 as illustrated in FIG. 1. The horizontal wall 158 includes a pair of holes 166 for accepting the engine bolts 14 therethrough. A bottom surface 170 of the horizontal wall 158 includes a stepped projection 172 extending downwardly therefrom at a location between the pair of holes 166. The stepped projection 172 includes a larger portion 174 at the bottom surface 170 and a smaller portion 176 centrally located on the larger portion 174. It is contemplated that the stepped projection 172 can be non-circular (e.g., oval). A fastener receiving opening 178 is centrally located in the stepped projection 172. It is contemplated that the fastener receiving opening 178 can include an internally threaded surface. The engine connection assembly 112 is configured to be abutted against and connected to the bottom surface 170 and the stepped projection 172 to connect the engine 10 to the engine connection bracket 104. It is contemplated that the engine connection bracket 104 can be formed of metal (e.g., cast ductile iron).

The illustrated engine connection assembly 112 is configured to affix the engine 10 to the engine connection bracket 104. The engine connection assembly 112 includes a pair of nuts 180, a fastener 182 and a lock plate 184. Each of the nuts 180 have a non-circular cross-sectional shape (e.g., hexagonal as illustrated). The lock plate 184 includes a pair of outer openings 186 having the same shape as the shape of the nuts 180 (e.g., hexagonal). The lock plate 184 also includes an inner opening 188 located between the outer openings 186. The fastener 182 can include an externally threaded post 190.

In the illustrated example, the engine connection assembly 112 is connected to the engine connection bracket 104 by first positioning the nuts 180 against the bottom surface 170 of the horizontal wall 158 of the L-shaped section 140 of the engine connection bracket 104 such that internally threaded holes 192 in the nuts 180 are aligned with one of the holes 166 in the horizontal wall 158. The lock plate 184 is then inserted over the nuts 180 with the nuts 180 extending through the outer openings 186 of the lock plate 184. While both the nuts 180 and the outer openings 186 are illustrated as having corresponding hexagonal shapes, it is contemplated that these elements could have any non-circular shape (although hexagonal is preferred). During assembly, the smaller portion 176 of the stepped projection 172 of the engine connection bracket 104 is also positioned through the inner opening 188 in the lock plate 184, thereby trapping a flange 194 of the nuts 180 between the bottom surface 170 of the horizontal wall 158 of the L-shaped section 140 of the engine connection bracket 104 and the lock plate 184. While both the smaller portion 176 of the stepped projection 172 of the engine connection bracket 104 through the inner opening 188 in the lock plate 184 are shown as being oval, it is contemplated that these elements could have any complementary shape (e.g., circular with other features preventing rotation of the lock plate 184 on the stepped projection 172 or non-circular to prevent rotation of the lock plate 184). The fastener 182 is then inserted into the fastener receiving opening 178 in the stepped projection 172 to fixedly connect the engine connection assembly 112 to the engine connection bracket 104. The corresponding shapes of the nuts 180 and the outer openings 186 of the lock plate 184 prevent rotation of the nuts 180 as the bolts 14 are inserted through the holes 166 in the horizontal wall 158 and screwed into the nuts 180. However, it is contemplated that the engine 10 could be affixed to the engine connection bracket 104 in any manner. Furthermore, while the engine connection assembly 112 is shown as being a separate component from the engine connection bracket 104 to allow these elements to be made of different materials (e.g., the engine connection assembly 112 being formed of steel parts and the engine connection bracket 104 being formed of iron), it is contemplated that the engine connection assembly 112 and the engine connection bracket 104 can be a single integral part (e.g., all formed of cast iron).

The illustrated overload pad 106 and the main pads 108 combine to dampen vibrations between the beam connection bracket 102 and the engine connection bracket 104 and thereby dampen vibrations passing from the engine 10 to the support beam 12.

The overload pad 106 and the main pads 108 are both substantially formed of elastomeric material, but can have different elastomers with different Bayshore resilience percentages and thereby with different dampening qualities. For example, the overload pad 106 and the main pads 108 can both be formed of polyurethane, but have different types of polyurethane with different Bayshore resilience percentages. In the illustrated example, the overload pad 106 exhibits a low Bayshore resilience percentage (and thereby a high dampening ratio) and the main pads 108 exhibit a high Bayshore resilience percentage (and thereby a low dampening ratio) to thereby combine to dampen a broader range of frequencies of oscillations passing from the engine 10 to the support beam 12 compared to prior art engine mounts. Therefore, the main pads 108 dampen higher vibration frequencies and the overload pad 106 dampens lower vibration frequencies. It is contemplated that the main pads 108 can have a Bayshore resilience percentage that falls between 35% and 90% while the overload pad 106 can have a Bayshore resilience percentage that falls between 0% and 20%.

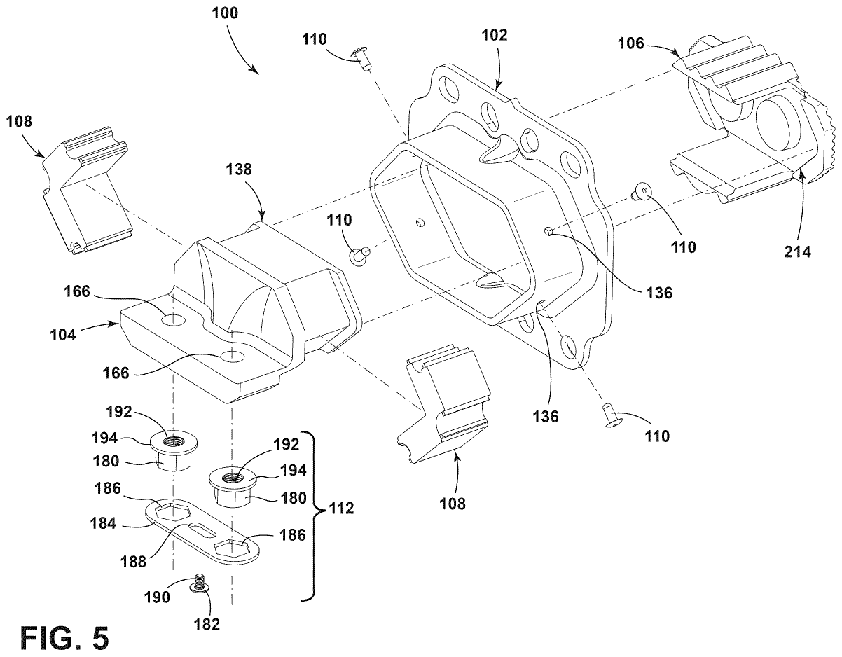

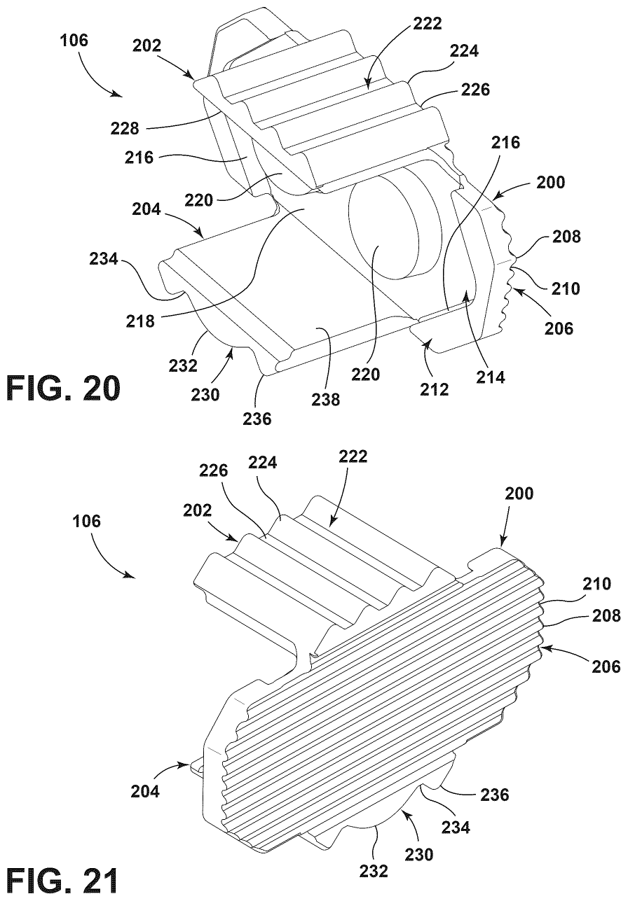

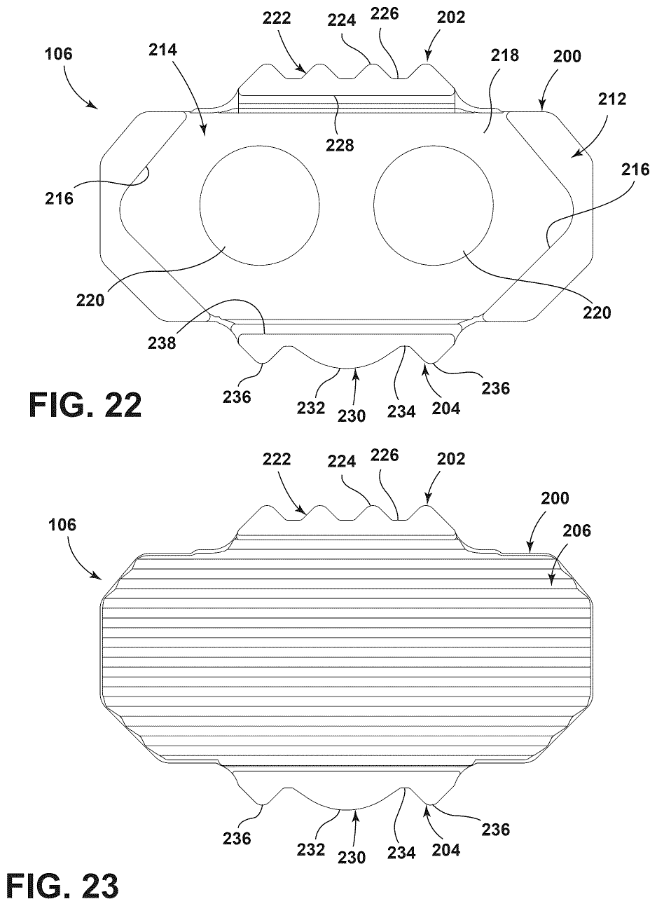

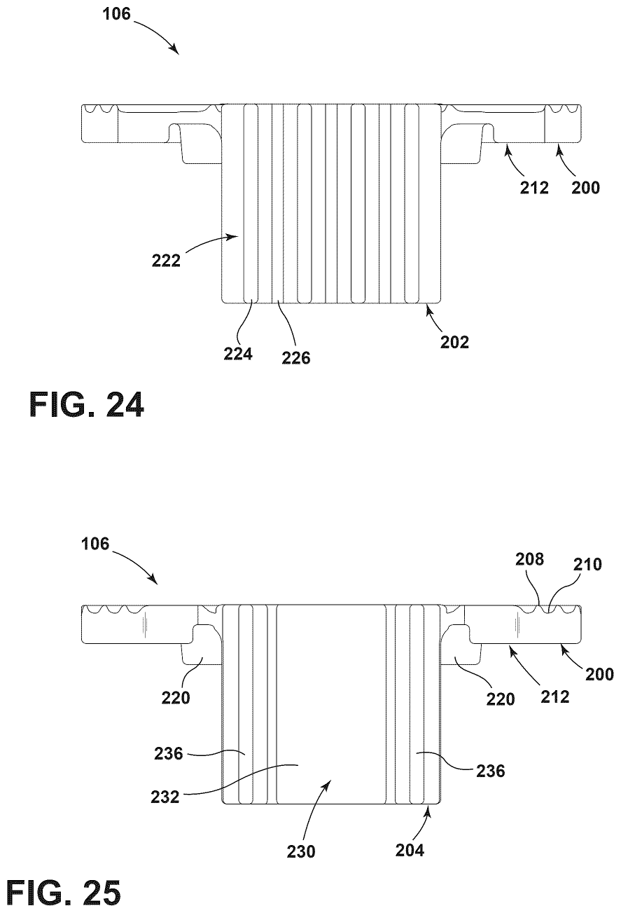

The illustrated overload pad 106 (see FIGS. 20-25) is located between the beam connection bracket 102 and the engine connection bracket 104 and abuts against the support beam 12. The overload pad 106 has a beam abutment portion 200, a top arm 202 and a bottom arm 204. The beam abutment portion 200 includes an undulated beam abutment surface 206 having a plurality of ridges 208 and troughs 210. The beam abutment portion 200 is configured to press against an engagement surface 13 of the support beam 12 (see FIG. 1). The beam abutment portion 200 includes an engine connection bracket engagement surface 212 opposite the undulated beam abutment surface 206. The engine connection bracket engagement surface 212 includes a hexagonal shaped recess 214 to conform to the hexagonal shape of the substantially hexagonally shaped body 142 of the main block section 138 of the engine connection bracket 104. The substantially hexagonally shaped body 142 of the main block section 138 of the engine connection bracket 104 is configured to be received within the hexagonal shaped recess 214 as shown in FIG. 5. The hexagonal shaped recess 214 includes a pair of opposite L-shaped walls 216 configured to abut the lips 150 of the substantially hexagonally shaped body 142 to assist in centering the substantially hexagonally shaped body 142 of the main block section 138 of the engine connection bracket 104 within the hexagonal shaped recess 214. A pair of circular alignment projections 220 extend from a floor 218 of the hexagonal shaped recess 214. The alignment projections 220 are configured to be received within the internal recesses 152 of the substantially hexagonally shaped body 142 of the main block section 138 of the engine connection bracket 104 when the substantially hexagonally shaped body 142 is received within the hexagonal shaped recess 214.

In the illustrated example, the top arm 202 and the bottom arm 204 of the overload pad 106 are configured to be positioned between the long sides 144 of the substantially hexagonally shaped body 142 of the main block section 138 of the engine connection bracket 104 and the tubular sleeve 116 of the beam connection bracket 102. The top arm 202 includes an undulated upper surface 222 configured to abut the top wall 130 of the tubular sleeve 116 of the beam connection bracket 102. The undulated upper surface 222 has a plurality of ridges 224 and troughs 226. While four ridges 224 are shown, it is contemplated that a different number of ridges or projections or different shapes could be used. A substantially flat lower surface 228 of the top arm 202 abuts one of the long sides 144 of the substantially hexagonally shaped body 142. The bottom arm 204 includes an undulated lower surface 230 configured to abut the bottom wall 132 of the tubular sleeve 116 of the beam connection bracket 102. The undulated lower surface 230 has a larger center arcuate ridge 232 with a smaller ridge 236 on both sides of the larger center arcuate ridge 232. Troughs 234 separate the larger center arcuate ridge 232 from the smaller ridges 236. While a single larger center arcuate ridge 232 and a pair of smaller ridges 236 are shown, it is contemplated that a different number of ridges or projections or different shapes could be used. A substantially flat upper surface 238 of the bottom arm 204 abuts one of the long sides 144 of the substantially hexagonally shaped body 142.

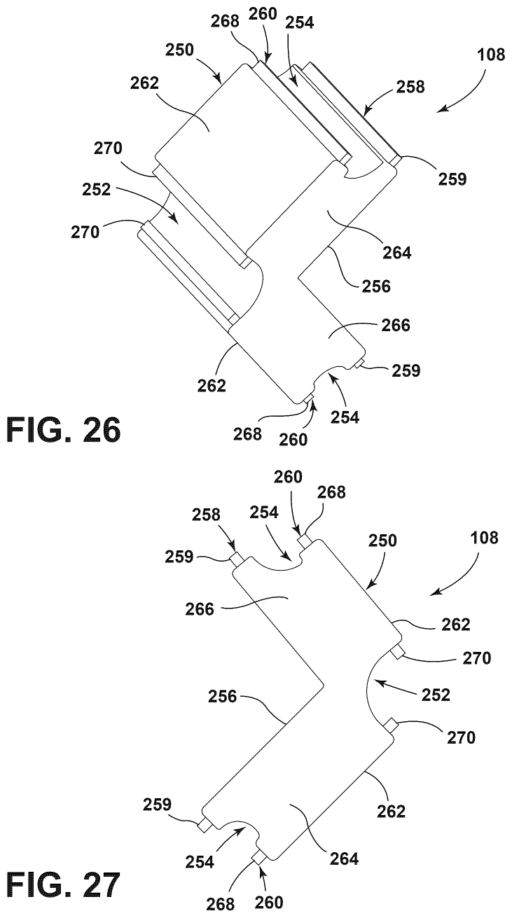

The illustrated main pads 108 (see FIGS. 26-27) work in conjunction with the overload pad 106 to dampen vibrations through the engine mount 100. Each of the main pads 108 includes an L-shaped body 250 having a longer leg 264 and a shorter leg 266. The L-shaped body 250 includes an outside corner recess 252 and a pair of end recesses 254 at end surfaces of the longer leg 264 and the shorter leg 266. An inner L-shaped plate 258 extends through the longer leg 264 and the shorter leg 266 adjacent an inner L-shaped surface 256 of the L-shaped body 250. The inner L-shaped plate 258 has exposed ends 259 that extend from ends of the longer leg 264 and the shorter leg 266 adjacent the end recesses 254 as illustrated in FIG. 27. An outer plate 260 is located in each of the longer leg 264 and the shorter leg 266 adjacent outer surfaces 262 thereof. The outer plates 260 have exposed ends 268 adjacent the end recesses 254 as illustrated in FIG. 27 and exposed ends 270 extending into the outside corner recess 252. The outer plates 260 are positioned substantially perpendicular to each other. The inner L-shaped plate 258 and the outer plates 260 are formed of metal (e.g., low carbon steel) while the rest of the main pads 108 can be formed of an elastomer (e.g., polyurethane).

In the illustrated example, the main pads 108 are located between the beam connection bracket 102 and the engine connection bracket 104. The inner L-shaped surfaces 256 of the main pads 108 are abutted against the angled sides 146 of the hexagonally shaped body 142 of the main block section 138 of the engine connection bracket 104. The outer surfaces 262 of the longer leg 264 and the shorter leg 266 of the L-shaped body 250 of the main pads 108 are abutted against the angled side walls 134 of the tubular sleeve 116 of the beam connection bracket 102. It is contemplated that the longer leg 264 is located below the shorter leg 266 in the final assembly position of the engine mount 100. Once the main pads 108 are located between the beam connection bracket 102 and the engine connection bracket 104, the fasteners 110 (e.g., rivets) are inserted through the fastener openings 136 in the tubular sleeve 116 of the beam connection bracket 102 and into the outer plates 260 in the main pads 108 to fix the main pads 108 in position.

With the illustrated engine mount 100 of the illustrated embodiment, all frequencies of vibrations passing between the engine 10 and the support beam 12 are dampened. A combination of the different materials of the overload pad 106 and the main pads 108 work in tandem to maximize the dampening characteristics of the engine mount 100 in a manner more efficient at dampening vibrations than the prior art engine mount 30. Moreover, the illustrated configurations of the overload pad 106 and the main pads 108 also assist in dampening vibrations, although other configurations are contemplated.

It is to be understood that variations and modifications can be made on the aforementioned structure without departing from the concepts of the present invention, and further it is to be understood that such concepts are intended to be covered herein unless expressly stated otherwise. Moreover, it is to be understood that such concepts are intended to be covered by the following claims unless these claims by their language expressly state otherwise.

What is claimed is:

1. An engine assembly for a truck, the engine assembly comprising:
an engine for powering the truck;
a support beam for supporting a portion of the engine;
an engine connection bracket connected to the engine by at least one first fastener;
a beam connection bracket connected to the support beam by at least one second fastener;
a first elastomer interposed between the engine connection bracket and the beam connection bracket; and
a second elastomer interposed between the engine connection bracket and the beam connection bracket;
wherein the first elastomer and the second elastomer are different materials and have different Bayshore resilience percentages.

2. The engine assembly according to claim 1, wherein:
the beam connection bracket includes a sleeve and a plate surrounding the sleeve, the first fasteners extending through the plate and into the support beam for connecting the beam connection bracket to the support beam;
the engine connection bracket is received within the sleeve;
the first elastomer and the second elastomer abut the sleeve.

3. The engine assembly according to claim 2, wherein:
the sleeve is substantially hexagonally-shaped having a pair of sleeves opposite long sides; and
the engine connection bracket comprises a substantially hexagonally-shaped body corresponding to an interior space defined by the sleeve.

4. The engine assembly according to claim 3, wherein:
the first elastomer comprises a substantially U-shaped body having a beam abutment portion, a top arm extending laterally from the beam abutment portion and a bottom arm extending laterally from the beam abutment portion;
the top arm and the bottom arm abutting the sleeve opposite long sides of the sleeve.

5. The engine assembly according to claim 4, wherein:
the beam abutment portion, the top arm and the bottom arm all include undulated surfaces, with the undulated surfaces of the top arm and the bottom arm being engaged with the sleeve.

6. The engine assembly according to claim 4, wherein:
the beam abutment portion includes a pair of projections extending into recesses in the substantially hexagonally-shaped body of the engine connection bracket.

7. The engine assembly according to claim 1, wherein:
the second elastomer is included in a pair of L-shaped pads, each of the L-shaped pads having an internal L-shaped plate with the second elastomer positioned over the internal L-shaped plate.

8. The engine assembly according to claim 7, wherein:
the beam connection bracket includes a sleeve and a plate surrounding the sleeve, the first fasteners extending through the plate and into the support beam for connecting the beam connection bracket to the support beam;
the engine connection bracket is received within the sleeve;
the first elastomer abuts a sleeve angled surface of the sleeve and a bracket angled surface of the engine connection bracket.

9. The engine assembly according to claim 1, further including:
an engine connection assembly comprising a pair of nuts having a non-circular exterior and a lock plate, the lock plate having a pair of openings corresponding to an exterior shape of the nuts, with the nuts extending into the openings in the lock plate;
wherein the first fasteners extend through the engine connection bracket and into the nuts of the engine connection assembly.

10. The engine assembly according to claim 1, wherein:
the first elastomer comprises polyurethane.

11. The engine assembly according to claim 1, wherein:
the second elastomer comprises polyurethane.

12. The engine assembly according to claim 1, wherein:
both the first elastomer and the second elastomer comprise polyurethane.

13. The engine assembly according to claim 1, wherein:
the first elastomer has a first Bayshore resilience that is 0%-20% while the second elastomer has a second Bayshore resilience that is 35%-90%.

14. An engine mount for connecting an engine to a support beam, the engine mount comprising:
an engine connection bracket configured to be connected to the engine by at least one first fastener;
a beam connection bracket configured to be connected to the support beam by at least one second fastener;
a first pad comprising a first elastomer interposed between the engine connection bracket and the beam connection bracket; and
at least one second pad comprising a second elastomer interposed between the engine connection bracket and the beam connection bracket;
wherein the first elastomer and the second elastomer are different materials and have different Bayshore resilience percentages.

15. The engine mount according to claim 14, wherein:
the beam connection bracket includes a sleeve and a plate surrounding the sleeve, the plate configured to receive the first fasteners therethrough for connecting the beam connection bracket to the support beam;
the engine connection bracket is received within the sleeve;
the first pad and the at least one second pad abut the sleeve.

16. The engine mount according to claim 15, wherein:
the sleeve is substantially hexagonally-shaped having a pair of sleeves opposite long sides; and
the engine connection bracket comprises a substantially hexagonally-shaped body corresponding to an interior space defined by the sleeve.

17. The engine mount according to claim 16, wherein:
the first pad comprises a substantially U-shaped body having a beam abutment portion, a top arm extending laterally from the beam abutment portion and a bottom arm extending laterally from the beam abutment portion;
the top arm and the bottom arm abutting the sleeve opposite long sides of the sleeve.

18. The engine mount according to claim 17, wherein:
the beam abutment portion, the top arm and the bottom arm all include undulated surfaces, with the undulated surfaces of the top arm and the bottom arm being engaged with the sleeve.

19. The engine mount according to claim 17, wherein:
the beam abutment portion includes a pair of projections extending into recesses in the substantially hexagonally-shaped body of the engine connection bracket.

20. The engine mount according to claim 14, wherein:
the at least one second pad comprises a pair of L-shaped pads, each of the L-shaped pads having an internal L-shaped plate with the second elastomer positioned over the internal L-shaped plate.

21. The engine mount according to claim 20, wherein:
the beam connection bracket includes a sleeve and a plate surrounding the sleeve, the first fasteners extending through the plate and into the support beam for connecting the beam connection bracket to the support beam;
the engine connection bracket is received within the sleeve;
the first pad abuts a sleeve angled surface of the sleeve and a bracket angled surface of the engine connection bracket.

22. The engine mount according to claim 14, further including:
an engine connection assembly comprising a pair of nuts having a non-circular exterior and a lock plate, the lock plate having a pair of openings corresponding to an exterior shape of the nuts, with the nuts extending into the openings in the lock plate;
wherein the first fasteners extend through the engine connection bracket and into the nuts of the engine connection assembly.

23. The engine mount according to claim 14, wherein:
the first elastomer comprises polyurethane.

24. The engine mount according to claim 14, wherein:
the second elastomer comprises polyurethane.

25. The engine mount according to claim 14, wherein:
both the first elastomer and the second elastomer comprise polyurethane.

26. The engine mount according to claim 14, wherein:
the first elastomer has a first Bayshore resilience that is 0%-20% while the second elastomer has a second Bayshore resilience that is 35%-90%.
